(19) United States
(12) Patent Application Publication
(10) Pub. No.: US 2010/0031477 A1
(43) Pub. Date: Feb. 11, 2010

(54) ADJUSTABLE RETAINER

(76) Inventors: Charles Lamar Harrison, Durham, NC (US); Warren Harding Daniels, JR., Stem, NC (US)

Correspondence Address: MOORE & VAN ALLEN PLLC, P.O. BOX 13706, Research Triangle Park, NC, 27709, US

(21) Appl. No.: 12/186,211

(22) Filed: Aug. 5, 2008

(51) Int. Cl. F16G 11/00

(52) U.S. Cl. 24/115 G; 24/115 R

(57) ABSTRACT

Embodiments of the present disclosure are directed to a retainer comprising a connecting member and a connector. The connector comprises a body having a first end and a second end, a first holding member, and a second holding member. The first holding member removably holds the first end of the connecting member, and the second holding member removably holds the second end of the connecting member.

### BACKGROUND OF THE INVENTION

Straps and other materials have various uses in today's world. For example, straps can be used in conjunction with a ratchet to hold down objects in the bed of a truck. In this instance, the straps can be of varying length but generally an excess amount of strap is left over after the strap is cinched to hold down the desired object. This excess is not contained in any manner. Other types of straps or materials in various applications also may not be contained and/or may hang freely from the application.

### BRIEF DESCRIPTION OF THE DRAWINGS

FIGS. 1A-B are perspective view of one embodiment of the invention.

FIG. 2 is a perspective view of another embodiment of the invention as applied to a roll of flat belt.

FIG. 3 is an exploded view of FIG. 2.

FIG. 4A is an exploded view of one embodiment of a connector.

FIG. 4B is a cross sectional view along the longitudinal length of the connector of FIG. 4A.

FIG. 5 is a perspective view of one embodiment of a holding member.

FIG. 6A is an exploded view of an embodiment of a connector with flanges.

FIG. 6B is a cross sectional view along the longitudinal length of the connector of FIG. 6A.

FIG. 7A is an exploded view of one embodiment of a connector with a stiffening collar.

FIG. 7B is a cross sectional view along the longitudinal length of the connector of FIG. 7A.

FIG. 8 depicts two embodiments of a strap core.

### DETAILED DESCRIPTION OF THE PREFERRED EMBODIMENT

Certain terminology is used herein for convenience only and is not to be taken as a limitation on the invention. For example, words such as “upper,” “lower,” “left,” “right,” “horizontal,” “vertical,” “upward,” “transverse,” and “downward” merely describe the configuration shown in the Figures. Indeed, the individual components may be oriented in any direction and the terminology, therefore, should be understood as encompassing such variations unless specified otherwise.

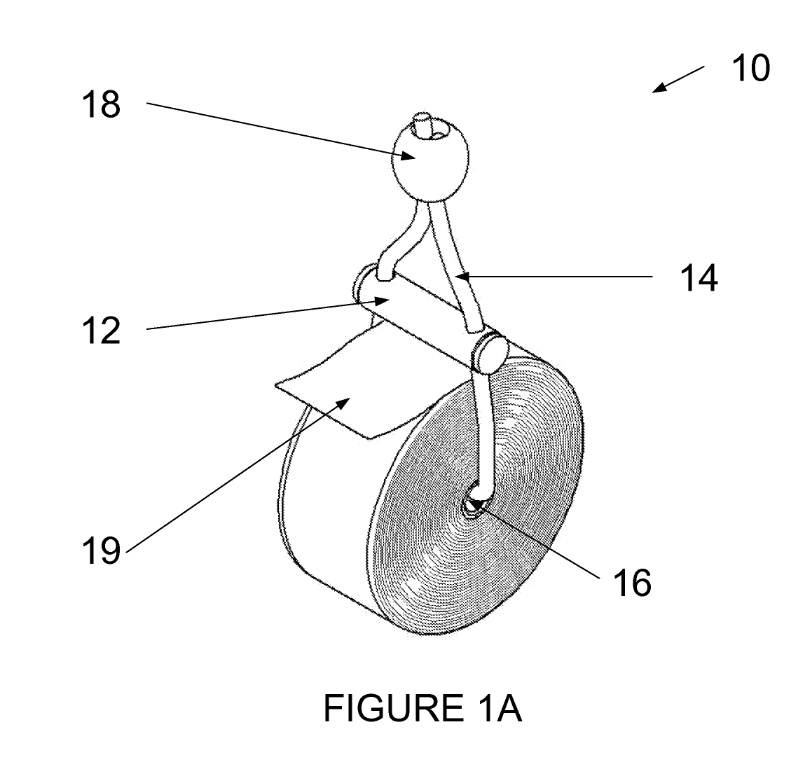

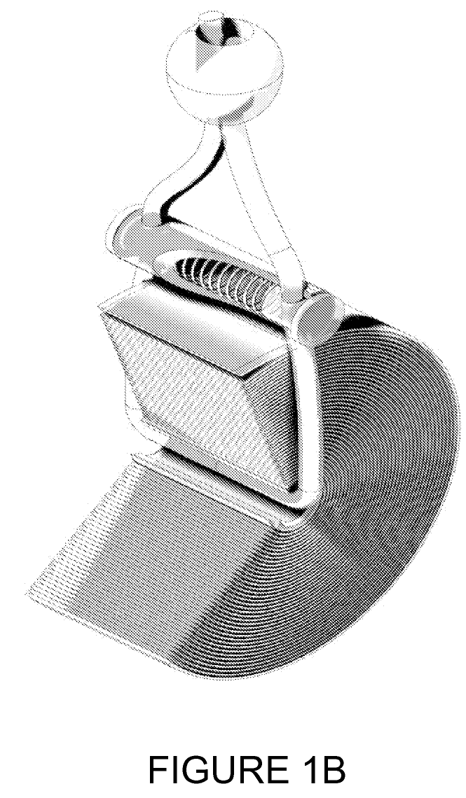

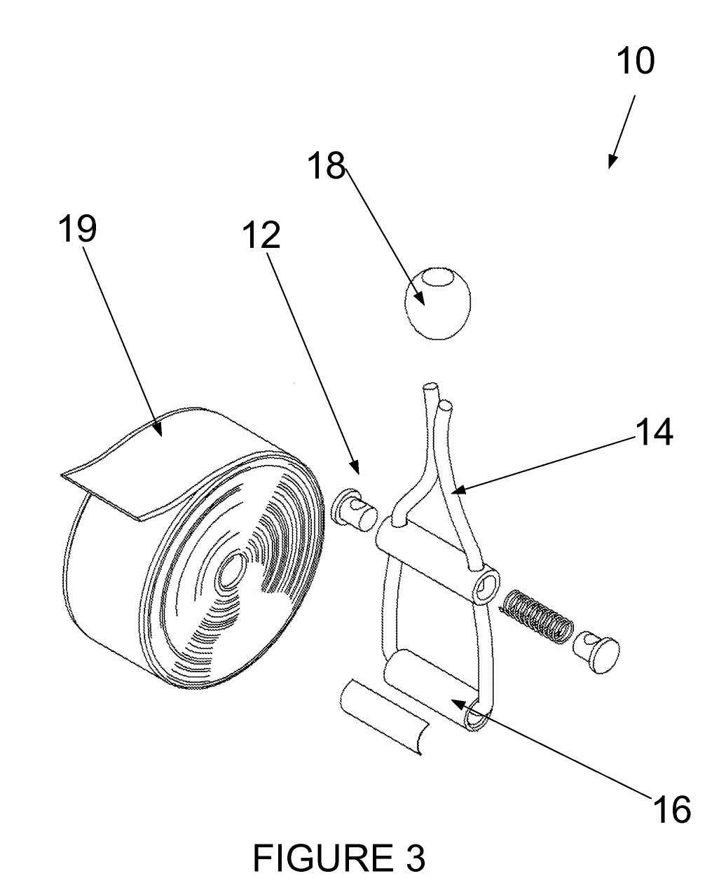

Referring now to the Figures, wherein like reference numbers refer to like elements in each of the several views, FIGS. 1-3 show an embodiment of an adjustable retainer 10. The adjustable retainer 10 may include a connector 12 and a connecting member 14. In some other embodiments, the adjustable retainer 10 may also feature a strap core 16 and a terminator 18. As shown in FIG. 1A, the adjustable retainer 10 may secure a strap 19 or belt securely to the adjustable retainer 10.

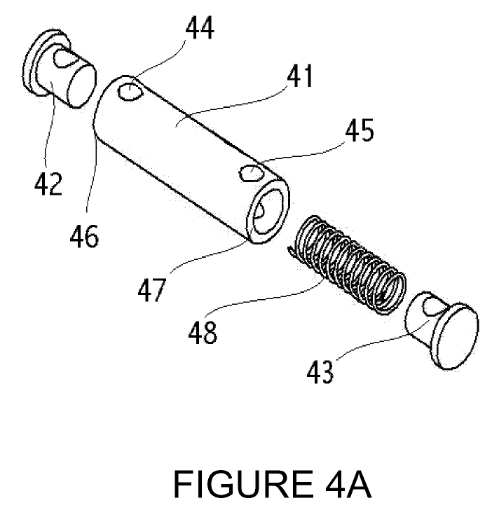

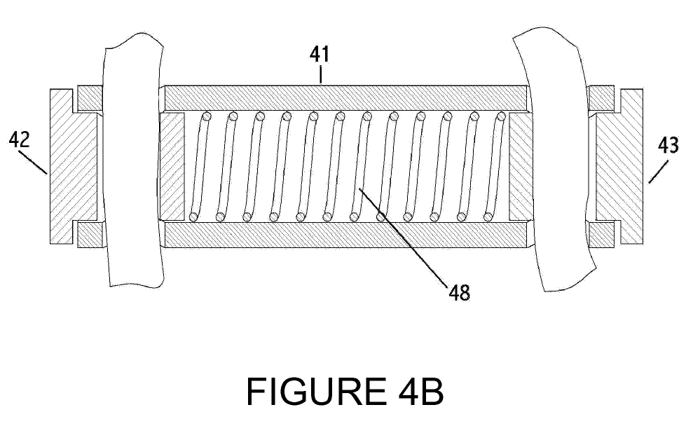

FIG. 4 depicts one embodiment of the connector 12. The connector 12 may include a body 41, a first holding member 42, and a second holding member 43. In one embodiment, shown in FIG. 4A, the connector 12 has a generally cylindrical shape; however, one skilled in the art can appreciate that other geometric shapes may be utilized, such as a box-like shape, hour-glass shape, shape such that the body has two separate portions and any other shape.

The body 41 of the connector 12 has at least one sidewall, a first passageway 44, a second passageway 45, a first end 46, and a second end 47. A first sidewall of the body 41 defines the first passageway 44 in the body 41. A second sidewall may define the second passageway 45 in the body 41. In one embodiment, the first sidewall may also define the second passageway 45. The first and second passageways 44, 45 may extend through at least a portion of the body 41 of the connector 12 so as to allow the connecting member 14 to pass therethrough. In one embodiment, the first passageway 44 is located at the first end 46 of the connector 12, while the second passageway 45 is located at the second end 47 of the connector 12. In another embodiment, the first and second passageways 44, 45 are located adjacent to the edges of the of the first end 46 and the second end 47, respectively such that the first and second passageways are separated from each other. Although the body heretofore has been described with passageways 44, 45, however, the body may not include any passageways but instead, may include other means that will allow the connector 12 to attach to the body 41. The crosssection of the body 41 may be of any shape at any location on the connector 12, such as substantially circular, square, triangular, pentagon-shape, hexagon-shaped, any combination thereof.

The connector 12 also includes two holding members 42, 43. The holding members 42, 43 may be located at any point on the connector, such as at each end 46, 47 of the body 41, at each passageway 44, 45, or at any other position on the connector 12. The holding members 42, 43 may be any device or item configured to engage, or to hold and release the connecting member 14 to the body 41 of the connector 12 via, e.g., the passageways 44, 45. For example, a holding member 42, 43 may be a spring-loaded button, clamp, buckle, pin, screw, crimping device, an adjustable passageway, adhesive, or any other device where the connecting member 14 will be held to the connector body 41.

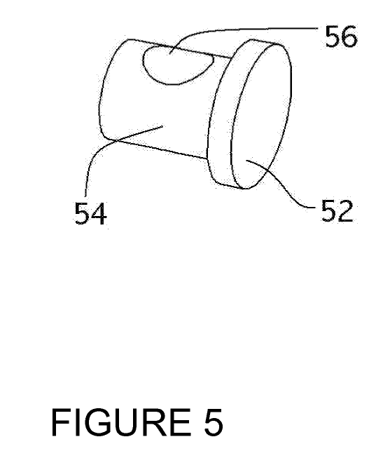

In one embodiment, as shown in FIG. 4A, the holding members 42, 43 are release buttons 50. As shown in FIG. 5, each release button may include a head 52 and body 54. The head 52 of each button 50 may be flat or have any other type of shape so as to be capable of being depressed by a user. In addition, the button head 52 may have a diameter that is greater than the diameter of the interior cavity of the connector body 41. The button head 52 is attached to the button body 54. The button body 54 may be generally cylindrical but alternatively may be of any other shape that allows the button body 54 to be inserted into the interior cavity of the connector body 41, such as triangular, square, or any other shape so that the button body 54 may be releaseably inserted into the interior cavity of the connector body 41. The button body 54 has a diameter less than that of the interior cavity of the connector body 41 so as to allow the button body 54 to freely slide back and forth into and out of at least a portion of the interior cavity of the connector body 41. Each button body 54 has a sidewall that defines a hole 56 in the button body 54. The button body hole 56 may be configured so as to align with a passageway in the connector body 41, such as when the button body 54 is inserted into the interior cavity of the connector body 41. The button body hole 56 may be roughly the same size as its respective passageway 44, 45 in the connector body 41. However, it should be understood that the size of the button body hole 56 may be larger or smaller than the respective passageway 44, 45.

As previously mentioned, the first and second release buttons 42, 43 may be located or releaseably connected to the interior cavity of the first and second ends 46, 47 of the connector body 41, respectively. In one embodiment, the buttons 50 may mate with the interior cavity of the connector body 41 so that the button body 54 is substantially flush with an internal surface of the interior cavity. The head 52 of each button 50 may be located outside of the interior cavity of the connector body 41 and each button head 52 may be located apart from the connector body 41. Although FIGS. 4A and 5 depict one embodiment in which release buttons 50 are utilized as holding members 42, 43, one of skill in the art will be aware that other holding members 42, 43, such as clamps, magnets, clips, and the like, that releaseably connect the connecting member 14 with the connector body 41 may be employed in conjunction with or instead of at least one button 50. Further, systems where the connecting member 14 and the holding member 42, 43 mate may be used, such as an adjustable belt and buckle system, a gear and brake system, a clamp system and the like.

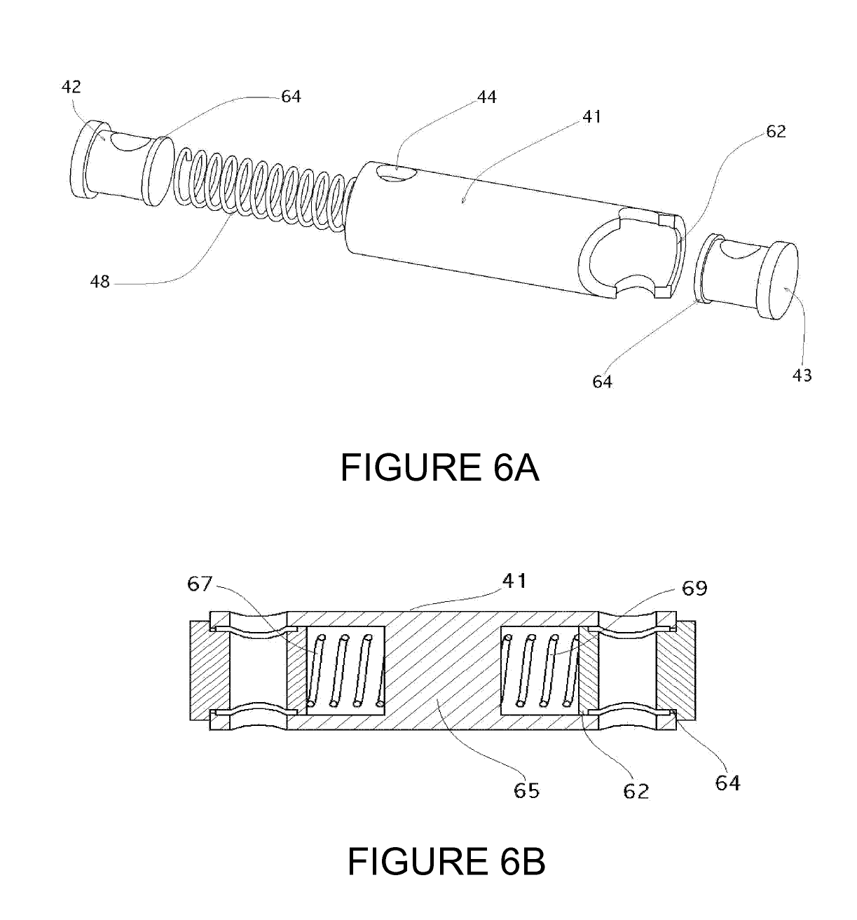

In one embodiment, as illustrated in FIG. 6, the connector 12 may incorporate one or more interference flanges, such as an internal flange 62 and an external flange 64. The internal flange 62 may be a lip or other protrusion located on the first end 46 and/or second end 47 of the connector body 41 and may extend inwardly toward the interior cavity of the connector body 47 or outwardly away from the interior cavity. The external flange 64 may include a lip or protrusion on an edge of the holding member 42, 43. The internal flange 62 and the external flange 64 are configured so as to geometrically interfere with each other. This interference causes the holding members 42, 43 to be captured by the connector body 41 so that, in the absence of a connecting member 14, the holding members 42, 43 will not disconnect from the connector body 41. It is to be understood that other reinforcement devices, materials, methods, or objects may be employed to prevent separation of the connector body 41 and the holding members 42, 43, and embodiments of the present invention is not only limited to flanges 62, 64.

The connector 12 may be spring-loaded by any device applying a force onto the holding member 42, 43, which in turn applies force to the connecting member 14, or the holding member may itself generate a force to apply to the connecting member 14. In one embodiment, a compression spring 48 may be inserted into the interior cavity of the connector body 41 to spring-load the connector 12. The compression spring 48 may be housed in the connector body 41. For example, as shown in FIG. 4, a spring 48 of a length to allow one end of the spring 48 to contact and apply force to one holding member 42, while the other end of the spring is aligned to contact and apply force to the other holding member 43. Examples of the spring 48 may include a steel compression spring, injected molded plastic spring, a material having a spring constant, or any other device or object capable of applying force to the connecting member 14.

In one embodiment, two or more springs may be employed where each spring contacts a single holding member 42, 43, as shown in FIG. 6B. An internal 65 wall may be integral with or placed in the connector body 41 with each spring 67, 69 and each spring 67, 69 may be positioned such that one end of each spring 67, 69 contacts the internal wall 65 and the other end contacts and applies force to a holding member 42, 43. This two-spring arrangement may apply a greater amount of force than a single spring, in some scenarios where, for example, an adjustable retainer 10 is being used on a strap, belt, or other material with a very large width or diameter where a greater amount of force is needed to be applied to the strap, belt, or other material to hold such items to the connector 12.

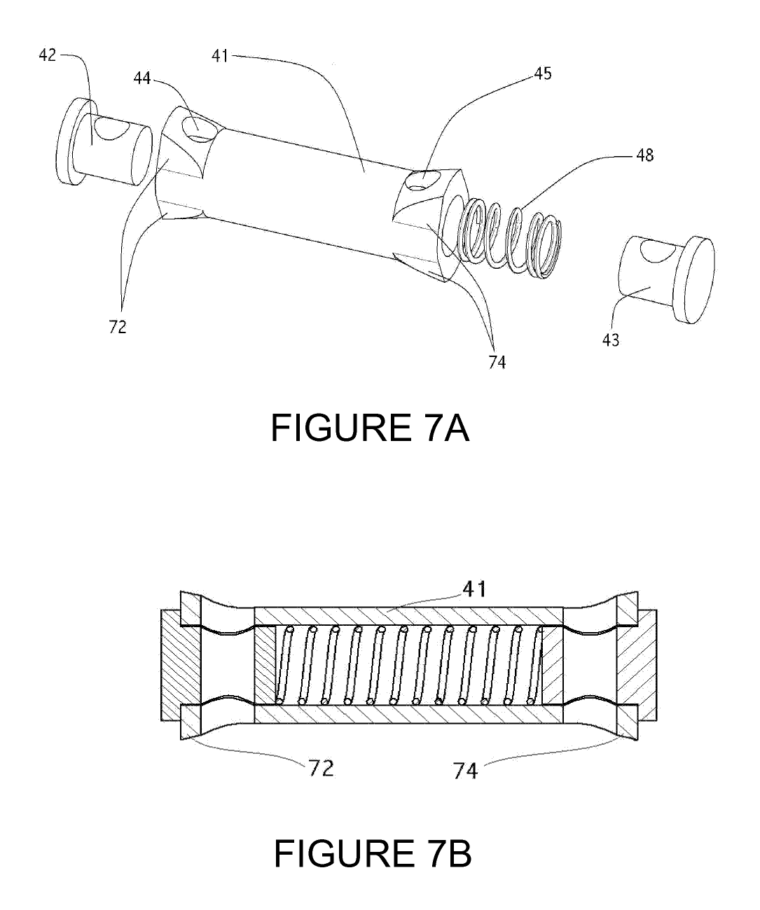

In another embodiment, the connector 12 may include at least one stiffening collar. A two-collar embodiment is shown in FIG. 7. In the depicted embodiment, each collar 72, 74 is configured to reinforce each respective passageway 44, 45 by providing extra support around the passageway 44, 45. Each collar 72, 74 may have an increased amount of material integrated with or connected to the connector body 41. The size of the collar 72, 74 may be dependent on the amount of force or stress that will be placed on the connector 12. For example, the higher amount of stress that will be placed on the connector 12, the larger the collar size should be to provide greater amount of support and stress distribution. The collar 72, 74 may be provided for each passageway opening, as shown in FIG. 7. It should be understood that other reinforcement devices, materials, methods, or objects may be employed to reinforce the passageways 44, 45 or holding members 42, 43 and the illustrated embodiments should not only limited to collars 72, 74 to reinforce the connector passageways 44, 45 or holding members 42, 43.

The connector 12 may be connected to the connecting member 14 such that the connector 12 makes a loop with the connecting member 14, forming a passageway therethrough such that a belt, strap and the like may pass therethough. Although, the connector is describe heretofore as making a loop, the connector need not form a loop to function, and instead only one end of the connecting member may be connected to the connector. Further, only one end of the connecting member may be moveable along the connector so that the other end of the connecting member may be fixed to the connector.

In one embodiment, the connecting member 14 may be any type of material capable of connecting to the connector 12, such as a line, rope, metal strip, plastic, any elastomeric material, wire, wood, leather, or any other material capable of forming a loop with the connector 12. In one embodiment, a line such as an elastic cord, rope, bungie line, and the like may be employed. Such an elastic line may be single or multi-stranded and may further include external shielding. The connecting member 14 may have a diameter capable of fitting through the holes of the connector 12. The connecting member 14 may be substantially conformable.

The ends 46, 47 of the connecting member 14 may be attached together in one embodiment by a terminator 18. By way of example, the ends 46, 47 may be manually tied together or may be held together using the terminator 18, such as a ball-tie, pin, clamp, glue, adhesive material, magnets, or any other means for attaching the ends 46, 47 together. In one embodiment, the ends 46, 47 of the connecting member 14 may be integral with each other 46, 47 such that the connecting member 14 is one intergral piece forming a loop with itself.

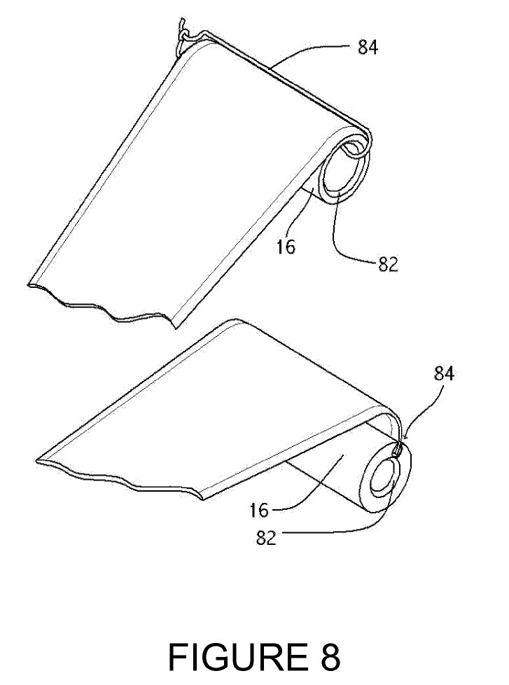

As shown in FIG. 8, embodiments of the adjustable retainer 10 may include a strap core 16. The strap core 16 may be a generally cylindrical object, but may have other shapes, such as a triangular or rectangular prism, any other polygon having any number of sides, or any other shape where a strap or belt can wrap around. The strap core 16 may include a sidewall that defines an internal cavity 82. The internal cavity 82 of the strap core 16 is such that the connecting member 14 can be placed therethrough. The strap core 16 may be configured such that it is capable of free movement, such as rolling, on the connecting member 14. In one embodiment, a spring (not shown) may be employed in the internal cavity 82 of the strap core 16 to facilitate rotation of the strap core 16 about the connecting member 14.

In some embodiments, the strap core 16 includes a means for adhering 84 the end of the strap or belt to the strap core 16, such as double sided core adhesive, a mechanical pin, a locking pin, a recess in the connector body, and the like, as shown in FIG. 8. For example, as shown in the lower illustration of FIG. 8, adhesive may be employed on the outer surface of the strap core 16. By way of another example, as shown in the upper illustration of FIG. 8, a recess or groove 84 in the strap core 16 may be employed so that an end of a belt may be inserted therein to attach the belt to the strap core 16. It should be understood that any other devices to secure a strap or belt to the strap core 16 may be employed and the present invention should not be limited only to the embodiments described above.

The strap core 16, connector body 41, and holding members 42, 43 may be made out of one or more plastics, composites, epoxies, metal, wood, polymers, any combination thereof or any other material possessing sufficient mechanical strength. In one embodiment, the material of the connector 12, including the connector body 41, holding members 42, 43, other possible elements of the connector 12, and the strap core 16, may be made of one or more materials, such as any thermoplastic material, including acetal copolymer, capable of withstanding high temperatures, including temperatures up to 160 degrees F., so that the connector will substantially not deform after being exposed to such temperatures. It is to be understood that the scope of the invention is not intended to be limited by the materials listed here, but may be carried out using any material which allows the construction and operation of the connector described herein.

Embodiments of the present invention may be used to retain, secure and/or store at least a portion of a belt, a strap or any other item, as previously mentioned. For example, a user may adhere the end of a belt to the core 16, or the connecting member 14. As previously mentioned, a means for facilitating the strap to adhere or connect to the strap core 16 or the connecting member 14 may be employed. The user may then roll or wrap the belt onto the strap core 16 or the connecting member 14. In one embodiment, as the user wraps the belt or strap around the strap core 16, the strap core may freely rotate about the connecting member 14. The strap is connected to the strap core 16 and the strap core 16 operates as an axis about which the strap rotates on. Continual rotation of the strap core 16 or the connecting member 14 so that the strap is accorded onto the strap core 16 and/or the connecting member 14 results in the strap being contained by the adjustable retainer 10. The amount of strap wrapped onto the retainer 10 may be variable as desired by the user.

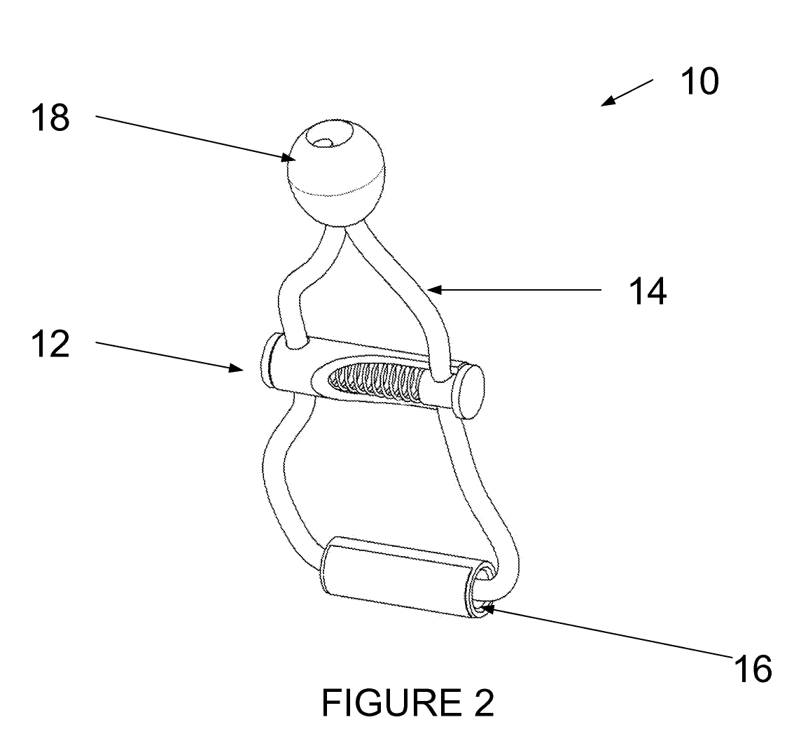

Once the belt is rolled onto the core 16 to a desired amount, the user may hold the belt or strap in place with one hand, while actuating or compressing the holding members 42, 43 from a relaxed state to a compressed state, compressing the spring 48 inside the interior cavity of the connector body 41. Keeping the holding members 42, 43 in the compressed position, the user may slide and/or cinch the connector 12 via the connector body passageways 44, 45 along the connecting member 14 until the connector 12 rests snuggly against the rolled belt, or to a desired position. The user then releases the holding members 42, 43 from the compressed state back to the relaxed state to hold the connecting member 14 by compressing the connecting member 14 between an edge of the passageway openings with an edge of the button holes. Such compression temporarily deforms the material therebetween causing the connecting member 14 to remain in its held position (as shown in FIG. 2), thus retaining the belt or strap as wrapped onto itself by the user. The belt or strap is held to the adjustable retainer 10 by a predetermined force. The greater the force applied by the connector 12 to the connecting member 14, the stronger the adjustable retainer 10 holds the wound strap in place.

To initially assemble the adjustable retainer 10, a machine or user depresses the buttons 50 so that the passageways 44, 45 align with the button holes. In the case that a holding member 42, 43 other than a button 50 is employed, the force being applied by the holding members 42, 43 is deactivated, such as by opening a clamp, disconnecting a clip, and the like. Once a passageway 44 is created, an end of the connecting member 14 is inserted therethrough and force of the holding member 42 is then reapplied, such as closing a clamp, connecting a clip, releasing the buttons so that the springs force compression of the connecting member 14 between the button 50 and the connector body 41, and any other way to active application of force by the holding member 42. This connects the one end of the connecting member 14 to the connector 12. The other end of the connecting member 14 is attached into the other holding member 43 in a similar manner to connect the other end of the connecting member 14 to the connector 12. Since two ends of the connecting member 14 are attached to the connector 12, a loop, which a strap, belt, and the like may pass therethrough, is created. The ends of the connecting member 14 may optionally, be attached together via the terminator 18.

It should be understood that the method of using embodiments of the present invention is offered by way of illustration and by no means is meant to limit the use of the adjustable retainer described herein. It should be understood by one of skill in the art that the method described in this example may be modified, including additions and omissions, without materially departing from the novel teachings and advantages of the invention.

Although embodiments of the present invention have been shown and described in considerable detail with respect to only a few/particular exemplary embodiments thereof, it should be understood by those skilled in the art that it is not intended to limit embodiments of the invention to the disclosed embodiments since various modifications, omissions, and additions may be made to the disclosed embodiments without materially departing from the novel teachings and advantages of the invention, particularly in light of the foregoing teachings.

1. An adjustable retainer comprising:
a connector comprising:
a body comprising a first end and a second end;
a first holding member located at the first end of the body; and
a second holding member located at the second end of the body; and
a connecting member comprising a first portion attached to the first end of the body, a second portion attached to the second end of the body and a third portion located between the first portion and the second portion;
wherein the first and second holding members are each capable of applying force to the connecting member to attach the connecting member to the connector.

2. The adjustable retainer of claim 1, wherein the connector further comprises a spring positioned between the first holding member and second holding member.

3. The adjustable retainer of claim 1, wherein the connector body further comprises:
a sidewall connected to the body and positioned between the first end of the body and the second end of the body, a first spring positioned between the first holding member and the sidewall; and
a second spring positioned between the second holding member and the sidewall.

4. The adjustable retainer of claim 1, further comprising a core, the core having a cylindrical shape and comprising a sidewall that defines at least one passageway through the body.

5. The adjustable retainer of claim 1, further comprising a strap fastener.

6. The adjustable retainer of claim 5, wherein the strap fastener is one of: double sided adhesive, a clip, and a retaining pin.

7. The adjustable retainer of claim 1, wherein the connector comprises thermoplastic material.

8. The adjustable retainer of claim 1, wherein the thermoplastic material is acetal copolymer.

9. The adjustable retainer of claim 1, wherein the connecting member is an elastic cord.

10. The adjustable retainer of claim 1, wherein the connector body further comprises a stiffening collar.

11. The adjustable retainer of claim 1, further comprising a means for attaching the first portion of the connecting member to the second portion of the connecting member so that the connector is positioned between the attaching means and the third portion of the connecting member.

12. An apparatus comprising:
a connector comprising:
a body having a first end, a second end, an interior portion, a first passageway and a second passageway,
a spring, wherein the spring is located in the interior portion of the body,
a first button located at the first end and having a head and a body, wherein the first button body having a sidewall defining a passageway, wherein the first button is positioned to contact the spring and move within the interior portion of the body, and
a second button having a head and a body, wherein the second button body having a sidewall defining a passageway, wherein the second button is positioned to contact the spring and move within the interior portion of the body.

13. The apparatus of claim 12, further comprising a line having a first end and a second end, the first end of the line attached to the first end of the connector and the second end of the line connected to the second end of the connector.

14. The apparatus of claim 13, further comprising a strap core attached to the line at a portion of the loop and configured to freely rotate about the line such that a strap may be wound upon the core.

15. The apparatus of claim 13, wherein the line comprises an elastic material.

16. The apparatus of claim 12, further comprising a fastener.

17. The apparatus of claim 12, wherein the connector body further comprises at least one flange located at the first end, wherein the flange comprises a protrusion extending from the first end towards the interior portion of the body.

18. The apparatus of claim 12, wherein the connector body further comprises a stiffening collar.

19. A method of retaining a wound strap, the method comprising:
winding a strap around a connecting member, the connecting member having a first end a second end and a middle portion, the first end of the connecting member being connected to a connector, the connector comprising:
a body having a first end and a second end and having a first sidewall defining a first passageway and a second sidewall to define a second passage way,
a first holding member that removably holds the connecting member to the body via the first passageway
a second holding member that removably holds the connecting member to the body via the second passageway
wherein the connecting member passes through the connector to make a loop,
actuating at least one of the first holding member and the second holding member of the connector so as to allow the connector to move toward the middle portion of the connecting member; and
moving the connector along the connecting member towards the middle portion of the connecting member.

20. The method of claim 19, wherein winding the strap around the connecting member comprises winding a strap upon a core connected to the connecting member.
